(19) United States
(12) Patent Application Publication
(10) Pub. No.: US 2026/0320470 A1
(43) Pub. Date: Oct. 15, 2026

(54) INTERACTIVE MLOps SYSTEM

(71) Applicant: Acryl Inc., Seoul (KR)

(72) Inventors: Su Gi Lee, Seoul (KR); Chan Yong Kim, Seoul (KR); Min Gyu Choi, Gyeonggi-do (KR); Hyun Kyeong Shin, Seoul (KR); Wei Jin Park, Seoul (KR)

(73) Assignee: Acryl Inc., Seoul (KR)

(21) Appl. No.: 18/859,329

(22) PCT Filed: Dec. 4, 2023
(86) PCT No.: PCT/KR2023/019813

§ 371 Date: Oct. 23, 2024

(30) Foreign Application Priority Data
Nov. 14, 2023 (KR) 10-2023-0157742

(51) Int. Cl. G06N 20/00

(52) U.S. Cl. CPC G06N 20/00

(57) ABSTRACT

An operating method of an interactive MLOps system according to an embodiment includes receiving an input message comprising a request related to a target artificial neural network model from a user, determining a process list to be provided by the interactive MLOps system, by inputting the request included in the input message into an internal artificial neural network model, transmitting a response message comprising the process list, receiving, from the user, a selection message comprising one or more selections from the process list, and building or updating a pipeline based on the request included in the input message and the selections included in the selection message.

### TECHNICAL FIELD

The following embodiments relate to an interactive MLOps system and an operating method thereof and, more particularly, to an interactive MLOps system for supporting automated artificial intelligence (AI) workflow generation.

### BACKGROUND ART

Conventional MLOps platforms provide convenient and automated methods of constructing and operating artificial intelligence (AI) for non-experts having no specialized knowledge in AI and computer systems.

However, these platforms require users to 1) determine the type, meaning, and usability of data that the users have, 2) plan a target AI service based on the data, and 3) select a type of AI model to be used in the service and then use the platform.

Such approaches are still perceived as very difficult for those who are ignorant of data or IT-related fields as well as AI, and increase the barrier to entry for utilization of MLOps platforms.

With the active and widespread use of AI and the advent of CHAT-GPT, humanities/arts companies or various content/product planners also require a new type of MLOps platform to solve such issues considering an increasing demand for AI construction.

### DISCLOSURE OF THE INVENTION

### Technical Goals

Embodiments provide a new type of MLOps platform that provides an environment where users communicate with a chatbot using the terminology used in their particular professions and a pipeline is constructed automatically based on the same.

The technical goals to be achieved by the present invention are not limited to those described above, and other technical goals not mentioned above can be clearly understood from the following description and accompanying drawings by one having ordinary skill in the technical field to which the present invention pertains.

### Technical Solutions

An operating method of an interactive MLOps system according to an embodiment may include receiving an input message including a request related to a target artificial neural network model from a user; determining a process list to be provided by the interactive MLOps system, by inputting the request included in the input message into an internal artificial neural network model; transmitting a response message including the process list; receiving, from the user, a selection message including one or more selections from the process list; and building or updating a pipeline based on the request included in the input message and the selections included in the selection message.

The interactive MLOps system may include a chatbot server configured to provide a messenger service that analyzes an utterance of the user and outputs a response to the utterance of the user.

The receiving of the input message may include receiving, from the user, an input message including user data related to the internal artificial neural network model.

The operating method of the interactive MLOps system according to an embodiment may further include analyzing and visualizing the user data.

The determining of the process list may include determining a type and meaning of the user data by inputting the user data into the internal artificial neural network model; and determining the process list appropriate for the type and meaning of the user data among all processes to be provided by the interactive MLOps system.

The operating method of the interactive MLOps system according to an embodiment may further include determining rankings of processes included in the process list based on the type and meaning of the user data.

The transmitting of the response message may include transmitting the response message including the rankings of the processes.

The determining of the process list may include determining a list of significant result types predictable by the target artificial neural network model from the user data.

The building or updating of the pipeline may further include providing the user with an interface to confirm a task performed by nodes within the pipeline, and providing an interface to modify respective detailed settings of the nodes.

The operating method of the interactive MLOps system according to an embodiment may further include providing an interface to deploy the built artificial neural network model.

The determining of the process list may include determining whether the request included in the input message is sufficient to determine the process list; specifying additional information required to determine the process list based on a determination that the request is insufficient; and generating a request message to obtain the additional information required and transmitting the request message to the user.

An interactive MLOps system according to an embodiment may include a chatbot providing module configured to receive an input message including a request related to a target artificial neural network model from a user; a data analyzing module configured to determine a process list to be provided by the interactive MLOps system, by inputting the request included in the input message into an internal artificial neural network model; and a pipeline building module, wherein the chatbot providing module may be configured to transmit a response message including the process list, and receive, from the user, a selection message including one or more selections from the process list, and the pipeline building module may be configured to build or update a pipeline based on the request included in the input message and the selections included in the selection message.

### BRIEF DESCRIPTION OF DRAWINGS

FIG. 1 is a block diagram of an interactive MLOps system according to an embodiment.

FIG. 2 is a diagram illustrating an example of chats between a user and a chatbot in an interactive MLOps system according to an embodiment.

FIG. 3 is a diagram illustrating an example of a pipeline according to an embodiment.

FIG. 4 is a flowchart illustrating an operating method of an interactive MLOps system according to an embodiment.

FIG. 5 is a block diagram illustrating an electronic device according to an embodiment.

### BEST MODE FOR CARRYING OUT THE INVENTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical or scientific terms have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like components, and any repeated description related thereto will be omitted.

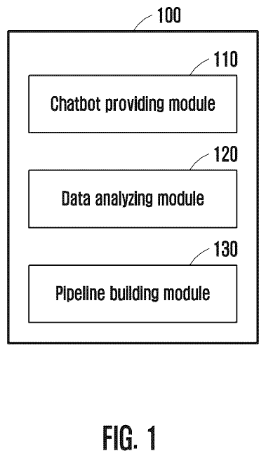

FIG. 1 is a block diagram of an interactive MLOps system according to an embodiment.

Referring to FIG. 1, an interactive MLOps system 100 according to an embodiment may include a chatbot providing module 110, a data analyzing module 120, and a pipeline building module 130. The term “module” used herein may be, for example, a unit including one or a combination of two or more of hardware, software, or firmware. The “module” may be interchangeably used with terms such as, for example, unit, logic, logical block, component, or circuit. The “module” may be a minimum unit of an integrally formed component or part thereof. The “module” may be a minimum unit for performing one or more functions or part thereof. The “module” may be implemented mechanically or electronically. For example, the “module” may include any one or any combination of an application-specific integrated circuit (ASIC) chip, field-programmable gate arrays (FPGAs), or a programmable-logic device that performs known operations or operations to be developed.

MLOps is a compound of machine learning and operations, and refers to maintaining, managing, and monitoring artificial neural network models for continuous and stable deployment in production environments. MLOps may automatically maintain, manage, and operate a ML system by integrating the development and operation of artificial neural network models. MLOps includes not only developing artificial neural network models but also collecting and analyzing data and training and deploying the artificial neural network model, that is, the entire artificial intelligence (AI) life cycle.

Conventional MLOps platforms provide an effective graphical user interface (GUI) and a pipeline-based user interface (UI) to provide a convenient AI construction environment to users. However, such UIs may also be very difficult and complex for users who have no AI and IT-related knowledge.

The interactive MLOps system 100 according to an embodiment may provide a chatbot based on a language model (e.g., a large language model (LLM) such as Chat-GPT), providing an environment where users communicate with the chatbot using the terminology used in their particular professions and a pipeline is constructed automatically based on the same.

A user may be a target who is provided with a service from the MLOps system 100 through a user terminal, and may also be referred to as a client, a customer, or the like. The user terminal according to an embodiment may be a device that receives a predetermined instruction from the user and drives a corresponding operation, and may be a digital device having an audio output function, a wired and wireless communication function, or other functions. According to an embodiment, the terminal may be a concept that includes all digital devices equipped with memory means and a microprocessor and having computing capabilities, such as a tablet PC, a smart phone, a personal computer (e.g., a laptop computer), a smart TV, a mobile phone, a navigation device, a web pad, a personal digital assistant (PDA), a workstation, and the like.

The user terminal according to an embodiment may include all user devices capable of installing and executing an application related to the MLOps system 100. At this time, the user terminal may perform the overall service operation, such as constructing a service screen, inputting data, transmitting and receiving data, and storing data under the control of the application. The application may be implemented to be used in a PC environment as well as a mobile environment, and may be implemented in the form of a program that operates independently or configured in an in-app form of a predetermined application to operate on the predetermined application.

The chatbot providing module 110 according to an embodiment may provide a chatbot service to a user. In the chatbot service, a chatbot may simulate human conversations using AI and natural language processing (NLP), thereby understanding the user's questions and automatically responding. The chatbot providing module 110 may also be referred to as a chatbot service below.

The chatbot providing module 110 may receive an input message including a request related to a target artificial neural network model from the user. The target artificial neural network model according to an embodiment may refer to an artificial neural network model desired by the user to construct. The user may input a message using the terminology in his/her profession, rather than the specialized terminology related to AI. The chatbot providing module 110 may input the input message from the user into a pre-trained language model to analyze the input message, thereby understanding the request included in the input image.

For example, the user may be ignorant of the type of neural network, such as a convolutional neural network (CNN), a recurrent neural network (RNN), or a generative adversarial network (GAN). In this case, the user may input a message of “I'd like to make an artificial neural network model to predict stock markets” in a colloquial form, rather than inputting an RNN or long short-term memory (LSTM) directly.

The data analyzing module 120 according to an embodiment may determine a response to the request included in the input message from the user using a pre-trained internal artificial neural network model. More specifically, the data analyzing module 120 may determine a process list to be provided by the interactive MLOps system, by inputting the request included in the input message into the internal artificial neural network model.

The data analyzing module 120 may determine whether data is insufficient to determine the response. If the data is insufficient to determine the response, the data analyzing module 120 may specify additional information required. Thereafter, the chatbot providing module 110 may generate a request message to obtain the additional information required and transmit the request message to the user.

For example, the chatbot providing module 110 may transmit questions of “Do you have any data right now?”, “How soon would you like to see the results?”, and “What percentage of performance accuracy would be good?” to the user and receive answers to the questions from the user.

When data sufficient to determine the response is obtained, the data analyzing module 120 may determine the process list to be provided by the interactive MLOps system.

For example, the data analyzing module 120 may determine, as the artificial neural network models to predict stock markets, a process list including 1) an LSTM model optimized with an accuracy of A% or more and an inference time of B hours or less and 2) an RNN model optimized with an accuracy of C% or more and an inference time of D hours or less.

The chatbot providing module 110 may transmit a response message including the process list to the user. At this time as well, the response message may be provided in a colloquial form, using the terminology the user can easily understand.

The user may select one or more from the process list through the chatbot, upon receiving the process list. Alternatively, if additional information is needed for selection, the user may request additional information through the chatbot.

The pipeline building module 130 may build a pipeline based on the request included in the input message and a selection included in a selection message. According to the request and selection from the user, an artificial neural network model may be constructed. The pipeline building module 130 may build the built artificial neural network as a pipeline-based UI and provide the UI to the user.

The pipeline building module 130 may analyze and visualize data. The pipeline building module 130 may represent data distribution in a type of graph desired by the user, and calculate and display various values such as average/variance.

The pipeline building module 130 may show the list of significant result types that can be predicted/computed by AI from the user data and induce the user to select.

The pipeline building module 130 may configure a pipeline to construct AI capable of predicting a result selected by the user and display the pipeline to the user.

The pipeline building module 130 may allow the user to confirm what task is performed by nodes within the pipeline, further, modify the detailed settings for the nodes, and start AI construction by clicking a “construction start” button if no modification is required.

The pipeline building module 130 may perform each operation in the pipeline when AI construction is started. Since AI model training includes the process of selecting a model with the highest accuracy from various types of models and the function of automatically adjusting the parameters of the model, those who have no AI-related knowledge may also construct high-performance AI.

The pipeline building module 130 may deploy the constructed AI to the service and control resources related to the model deployment through the chatbot.

The interactive MLOps system 100 according to an embodiment may provide AI construction at a low cost for services of humanities/arts companies barely having IT-related knowledge/personnel. Further, the interactive MLOps system 100 may deploy/operate services using chatbots, helping many companies reduce service maintenance personnel.

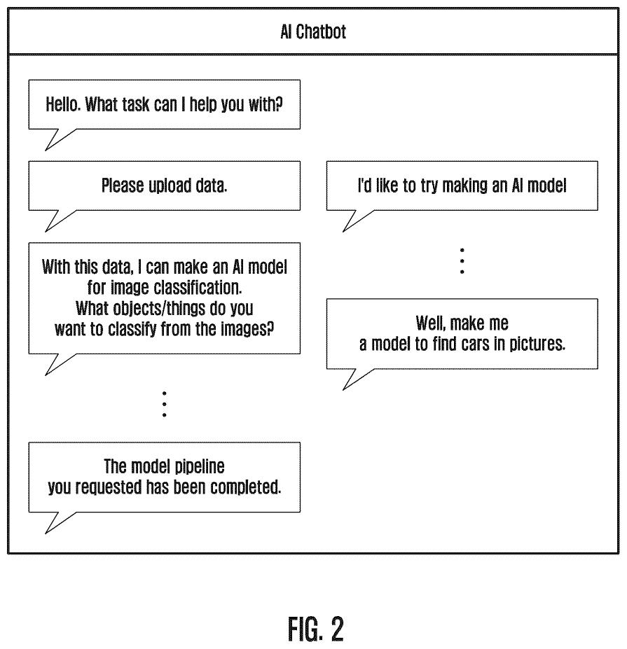

FIG. 2 is a diagram illustrating an example of chats between a user and a chatbot in an interactive MLOps system according to an embodiment.

Referring to FIG. 2, an interactive MLOps system according to an embodiment may provide a service in which a chatbot can have conversations with users using the terminology in their professions, rather than the specialized terminology related to AI.

For example, the chatbot may transmit a message of “Hello. What task can I help you with?” to the user, and the user may input an input message of “I'd like to try making an AI model” as a response thereto.

At this time, the chatbot may discern a request for ‘artificial neural network model generation’ from the input message of “I'd like to try making an AI model”. Further, the chatbot may be trained to discern the same request for ‘artificial neural network model generation’, not only when “I'd like to try making an AI model” is received but also when an input message of “What should I do to create machine learning?” is received.

Thereafter, the chatbot may transmit a request message of “Please upload data.” to the user and receive input data from the user.

The interactive MLOps system may determine a process list to be provided by the interactive MLOps system by inputting the request included in the input message, the input data, and response data into an internal artificial neural network model.

Furthermore, the chatbot may transmit a response message of “With this data, I can make an AI model for image classification. What objects/things do you want to classify from the images?” to the user, and receive a selection message of “Well, make me a model to find cars in pictures” from the user.

The interactive MLOps system may build or update a pipeline based on the request included in the input message and a selection included in the selection message.

Thereafter, the chatbot may transmit a message of “The model pipeline you requested has been completed.” to the user.

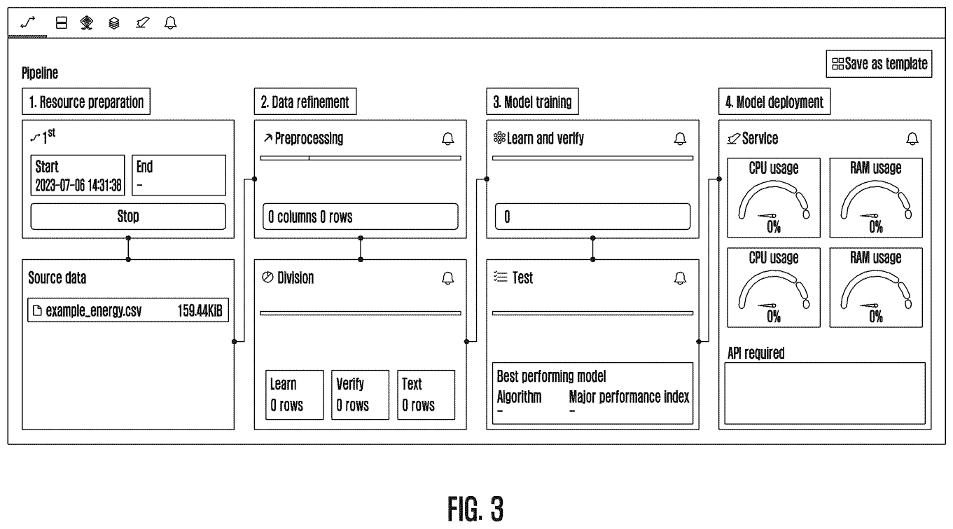

FIG. 3 is a diagram illustrating an example of a pipeline according to an embodiment.

Referring to FIG. 3, an interactive MLOps system according to an embodiment may construct a constructed artificial neural network as a pipeline-based UI and provide the same to a user.

The pipeline UI according to an embodiment may include a resource preparation UI, a data refinement UI, a model training UI, and a model deployment UI. However, FIG. 3 merely shows an example of a pipeline-based UI, and embodiments are not necessarily limited thereto.

The interactive MLOps system may perform easy AI training. For example, the interactive MLOps system may provide a GUI environment where a data-customized AI model can be selected and trained with just a click.

The interactive MLOps system may reduce model construction time and cost. For example, the interactive MLOps system may reduce AI construction time and cost by providing high-performance AI models for language/visual/emotional analysis.

The interactive MLOps system may operate automated AI. For example, the interactive MLOps system may support a function of automatically re-learning service operation data that enables service-customized advanced AI operation.

The interactive MLOps system may provide efficient model learning. For example, the interactive MLOps system may provide distributed node processing technology that enables distributed learning and an integrated memory function for high-capacity model learning.

The interactive MLOps system may provide efficient learning schedule management. For example, the interactive MLOps system may provide fast learning through automatic sequential progress of learning various parameter settings and acceleration of communication between GPUs.

The interactive MLOps system may provide a convenient development environment. For example, the interactive MLOps system may support interoperation with the previously used development environment and custom code tuning.

The interactive MLOps system may provide large-scale resource monitoring. For example, the interactive MLOps system may monitor the operational status of GPU resources and manage a network interface between GPU servers.

The interactive MLOps system may provide purpose-specific GPU management. For example, the interactive MLOps system may generate a workspace, assign GPU resources, and efficiently manage the assigned GPU resources.

The interactive MLOps system may provide quick fault detection. For example, the interactive MLOps system may discover faults quickly through real-time status monitoring and support accurate cause analysis.

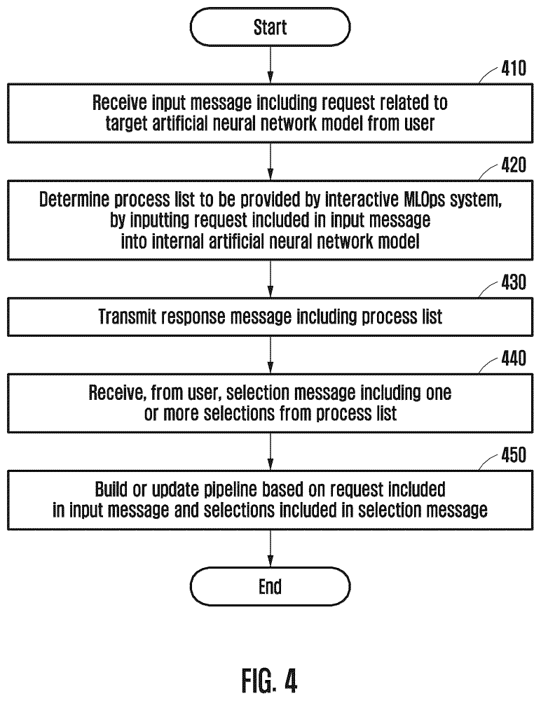

FIG. 4 is a flowchart illustrating an operating method of an interactive MLOps system according to an embodiment.

For ease of description, operations 410 to 450 are described as being performed using the interactive MLOps system 100 shown in FIG. 1. However, operations 410 to 450 may be performed by any suitable electronic device and in any suitable system.

Further, the operations in FIG. 4 may be performed in the shown order and manner. However, the order of some operations may change, or some operations may be omitted, without departing from the spirit and scope of the shown embodiment. The operations shown in FIG. 4 may be performed in parallel or simultaneously.

In operation 410, an interactive MLOps system according to an embodiment may receive an input message including a request related to a target artificial neural network model from a user. The interactive MLOps system may receive, from the user, an input message including user data related to an internal artificial neural network model. For example, the user may upload data (e.g., text, an image, a video, etc.) the user has to a chatbot.

In operation 420, the interactive MLOps system according to an embodiment may determine a process list to be provided by the interactive MLOps system, by inputting the request included in the input message into the internal artificial neural network model.

The interactive MLOps system may determine the type and meaning of the data based on its own AI and show the user a possible process list (data analysis/visualization, AI construction, etc.) to induce the user to select. More particularly, the interactive MLOps system may determine the type and meaning of the user data by inputting the user data into the internal artificial neural network model, and determine a process list appropriate for the type and meaning of the user data among all processes to be provided by the interactive MLOps system.

Further, the interactive MLOps system may determine rankings of processes included in the process list based on the type and meaning of the user data. For example, when a process list including five processes is determined, the priority between the five processes may be determined. The priority may be determined based on the type and meaning of the user data.

The interactive MLOps system may determine a list of significant result types predictable by the target artificial neural network model from the user data.

The interactive MLOps system may determine whether the request included in the input message is sufficient to determine the process list, specify additional information required to determine the process list based on a determination that the request is insufficient, generate a request message to obtain the additional information required, and transmit the request message to the user.

In operation 430, the interactive MLOps system according to an embodiment may transmit a response message including the process list. The interactive MLOps system may transmit a response message including the rankings of the processes

In operation 440, the interactive MLOps system according to an embodiment may receive, from the user, a selection message including one or more selections from the process list.

In operation 450, the interactive MLOps system according to an embodiment may build or update a pipeline based on the request included in the input message and the selections included in the selection message.

The interactive MLOps system may provide the user with an interface to confirm a task performed by nodes within the pipeline, and provide an interface to modify respective detailed settings of the nodes.

The interactive MLOps system may provide an interface to deploy the built artificial neural network model.

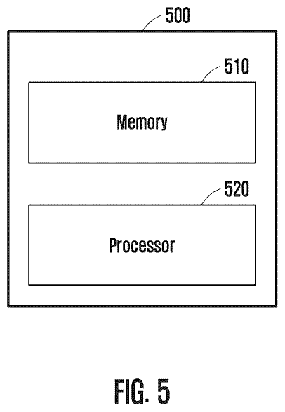

FIG. 5 is a block diagram illustrating an electronic device according to an embodiment.

In FIG. 5, one or more blocks and a combination thereof may be implemented by a special-purpose hardware-based computer that performs a predetermined function, or a combination of computer instructions and special-purpose hardware. The description provided with reference to FIGS. 1 to 4 may also apply to FIG. 5 likewise. For example, an electronic device 500 according to an embodiment may include the interactive MLOps system 100.

As in FIG. 5, the electronic device 500 may include a memory 510 and a processor 520. The electronic device 500 may further include a communication module, and the communication module may include a transmitter and a receiver.

The electronic device 500 according to an embodiment may include the memory 510 and the processor 520 connected to the memory 510 through a system bus or other appropriate circuitry.

The electronic device 500 may store program code in the memory 510. The memory 510 according to an embodiment may include a local memory or at least one physical memory device, such as one or more bulk storage devices. Here, the local memory may include random-access memory (RAM), or other volatile memory devices generally used during actual execution of the program code. The bulk storage devices may be implemented as a hard disk drive (HDD), a solid-state drive (SSD), or other non-Volatile memory devices.

When executable program code stored in the memory 510 is executed by the electronic device 500, the processor 520 may perform various operations disclosed herein. For example, the memory 510 may store program code such that the processor 520 may perform the one or more operations disclosed with reference to FIGS. 1 to 4.

Depending on the specific type of device to be implemented, the electronic device 500 may include fewer components than the shown components or may include additional components not illustrated in FIG. 5. Also, one or more components may be included in another component or may form part of another component.

The processor 520 according to an embodiment is a hardware configuration that performs overall control functions for controlling the operations of the electronic device 500. For example, the processor 520 may execute programs stored in the memory 510 of the electronic device 500 to control the electronic device 500 overall. The processor 520 may be implemented as a central processing unit (CPU), a graphics processing unit (GPU), an application processor (AP), a neural processing unit (NPU), or the like provided in the electronic device 500, but is not limited thereto.

The processor 520 may receive an input message including a request related to a target artificial neural network model from a user, determine a process list to be provided by the interactive MLOps system, by inputting the request included in the input message into an internal artificial neural network model, transmit a response message including the process list, receive, from the user, a selection message including one or more selections from the process list, and build or update a pipeline based on the request included in the input message and the selections included in the selection message.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

A number of embodiments have been described above. Nevertheless, it should be understood that various modifications may be made to these embodiments. For example, suitable results may be achieved if the described techniques are performed in a different order, and/or if components in a described system, architecture, device, or circuit are combined in a different manner, and/or replaced or supplemented by other components or their equivalents.

Accordingly, other implementations are within the scope of the following claims.

1. An operating method of an interactive MLOps system, the operating method comprising:
receiving an input message comprising a request related to a target artificial neural network model from a user;
determining a process list to be provided by the interactive MLOps system, by inputting the request included in the input message into an internal artificial neural network model;
transmitting a response message comprising the process list;
receiving, from the user, a selection message comprising one or more selections from the process list; and
building or updating a pipeline based on the request included in the input message and the selections included in the selection message.

2. The operating method of claim 1, wherein the interactive MLOps system comprises:
a chatbot server configured to provide a messenger service that analyzes an utterance of the user and outputs a response to the utterance of the user.

3. The operating method of claim 1, wherein the receiving of the input message comprises:
receiving, from the user, an input message comprising user data related to the internal artificial neural network model.

4. The operating method of claim 3, further comprising:
analyzing and visualizing the user data.

5. The operating method of claim 3, wherein the determining of the process list comprises:
determining a type and meaning of the user data by inputting the user data into the internal artificial neural network model; and
determining the process list appropriate for the type and meaning of the user data among all processes to be provided by the interactive MLOps system.

6. The operating method of claim 5, further comprising:
determining rankings of processes included in the process list based on the type and meaning of the user data.

7. The operating method of claim 6, wherein the transmitting of the response message comprises:
transmitting the response message comprising the rankings of the processes.

8. The operating method of claim 3, wherein the determining of the process list comprises:
determining a list of significant result types predictable by the target artificial neural network model from the user data.

9. The operating method of claim 1, wherein the building or updating of the pipeline further comprises:
providing the user with an interface to confirm a task performed by nodes within the pipeline; and
providing an interface to modify respective detailed settings of the nodes.

10. The operating method of claim 1, further comprising:
providing an interface to deploy the built artificial neural network model.

11. The operating method of claim 1, wherein the determining of the process list comprises:
determining whether the request included in the input message is sufficient to determine the process list;
specifying additional information required to determine the process list based on a determination that the request is insufficient; and
generating a request message to obtain the additional information required and transmitting the request message to the user.

12. A computer program stored in a computer-readable storage medium to execute the operating method of claim 1 in combination with hardware.

13. An interactive MLOps system comprising:
a chatbot providing module configured to receive an input message comprising a request related to a target artificial neural network model from a user;
a data analyzing module configured to determine a process list to be provided by the interactive MLOps system, by inputting the request included in the input message into an internal artificial neural network model; and
a pipeline building module, wherein the chatbot providing module is configured to:
transmit a response message comprising the process list, and receive, from the user, a selection message comprising one or more selections from the process list, and
the pipeline building module is configured to:
build or update a pipeline based on the request included in the input message and the selections included in the selection message.
